(19) United States
(12) Patent Application Publication
(10) Pub. No.: US 2018/0028411 A1
(43) Pub. Date: Feb. 1, 2018

(54) Baby Food Canteen

(71) Applicant: Lily Vosoughi Venezia, Lagrangeville, NY (US)

(72) Inventor: Lily Vosoughi Venezia, Lagrangeville, NY (US)

(21) Appl. No.: 15/224,021

(22) Filed: Jul. 29, 2016

(51) Int. Cl. A61J 9/00; A61J 11/04; B65D 81/38; A61J 11/00

(52) U.S. Cl. CPC A61J 9/005; A61J 11/0085; A61J 11/045; A61J 11/002; B65D 81/3888

(57) ABSTRACT

A reusable, flexible container for baby food, interlocking twist top ring, and snap into place cap. This includes a spout with an opening big enough for pureed food to fit through by means of the combined action of squeezing the attached container and sucking the spout simultaneously. The container is soft, hollow, squeezable and pliable so that a baby can safely play with, chew on, squeeze and eat from an edge-free container used by either an infant/toddler to feed himself/herself or be fed from by an adult. The top for the container may be readily twisted open so as to pour in pureed food contents, sealed shut to keep contents fresh for longer, and easily sanitized as the container has an opening once the top is twisted off for convenient cleaning.

### BACKGROUND OF INVENTION

This invention is related to a squeezable and flexible container for baby food. Containers for baby food with a feeding spout have been invented before; however, there are a number of problems with the current options available, for which solutions have not yet been created.

Currently, the existing designs create safety concerns for parents like myself. The shape of the baby food containers with a feeding spout from which babies can be fed directly without the assistance of a spoon, have somewhat sharp edges along the seams of the container leading up to the spout and around the container perimeter as a whole. The flattened seams along the edges of these containers can scrape, cut or create red marks along the babies' hands or mouth when simply rubbed against, played with or while trying to suck the spout to get food.

At this time, we need a container free of sharp, hard edges or flattened seams, a container that is rounded and safe for the baby to rub, squeeze, play with and put in their mouths, without causing scratches, red marks or abrasions. Mothers shouldn't have to worry that their baby's food container could cause harm if left for the baby to hold, as babies tend to play with their food container or excessively touch it out of curiosity.

At this time, baby food containers are often disposable or the ones that are reusable are difficult to wash as the pureed food often is trapped in said container's crevices. Out of concern for health risks associated with improper sanitation, it is necessary to have a container with a wide opening and a shape that is free of inaccessible folds or creases, a container that can be conveniently cleaned wherein any remaining residue can easily be seen and removed.

Additionally, once the cap is removed on the available baby food containers, it requires only a light squeeze or interchangeably, a mild sucking action and the pureed food gushes out. It is necessary to have a food container with a feeding spout and container that retains a safety precaution of requiring both squeezing and sucking simultaneously before the pureed contents exit the spout—which indicates the baby or toddler is ready for more food or that food should come out, so that food doesn't spill out so readily.

With the current baby food containers, food spills out too easily, often accidentally and creates a mess when the cap is off. Additionally, the baby can choke if the food continually pours out so readily while the baby is still chewing or swallowing the food that's already been squeezed into his/her mouth, overloading the baby's mouth full with pureed food. This may also create a negative feeding experience for the baby. This invention is created to resolve such problems and concerns with previous design flaws in baby food containers with a spout.

### BRIEF SUMMARY OF INVENTION

My invention relates to new and useful improvements in a container for feeding a baby and containing a baby's food.

One of the objectives of the invention is to provide a container that is extremely durable, collapsible, reusable, safe for babies, and light in weight.

An object of the invention is to provide a container that is collapsible and foldable, so that it will take up minimal space while being transported.

An object of the invention is to implement a safety precaution of requiring both a sucking and squeezing motion in order for the baby food to come out of the container, so that the risk of accidental spillage is minimized; and henceforth, a positive feeding experience is accomplished for the baby or toddler.

Another object of the invention is to provide a container that is free of any sharp edges when folded, bent or full with contents of food, so that it is safe for babies and toddlers to hold, squeeze, chew and put in their mouths, without the risk of aforementioned activities causing cuts or abrasions.

Another object of the invention is to provide a container that is not only light in weight and will maintain the temperature of the contents (that is, the baby food) in the container for two to three hours; but will also protect the container from breakage if it is dropped, pulled, bitten or thrown against an article or the floor.

Additionally, another object of the invention is to provide a container that may be kept sanitary through wash and reusability. The rubber container may be readily opened as the top can be twisted off the body so that it can be conveniently washed after each use, if any pureed food or contents should remain in the container after use.

For simplicity purposes, the previously specified materials and materials listed in the following example specifies a design using plastic and rubber, but is not restricted to just that. It's by design that you can have multiple types of material suitable for the device with similar properties or characteristics to that of materials like plastic or rubber. This unique design could also be used for other materials that are safe for babies.

With these and other objects in view, the invention consists in certain new and novel arrangements and combination of parts, as will hereinafter be more fully described and pointed out in the claim.

### BRIEF DESCRIPTION OF DRAWINGS

Referring now to the drawings, showing a preferred embodiment. Various configurations of the present invention are shown and described in reference to the numbered drawings wherein:

FIG. 1 shows a full section view of the baby food container in its entirety:

FIG. 2 shows a perspective view of the baby food container in its entirety;

FIG. 3 shows an exploded view of a possible configuration of the baby food container.

These drawings are illustrative but not limiting of the scope of the invention, which is defined by the supplemented claims. The configurations here accomplish various components and objects of the invention; however, it is riot possible to depict each element and aspect of the invention in one figure so it has been separately illustrated to show the various features with clarity.

### DETAILED DESCRIPTION OF THE INVENTION

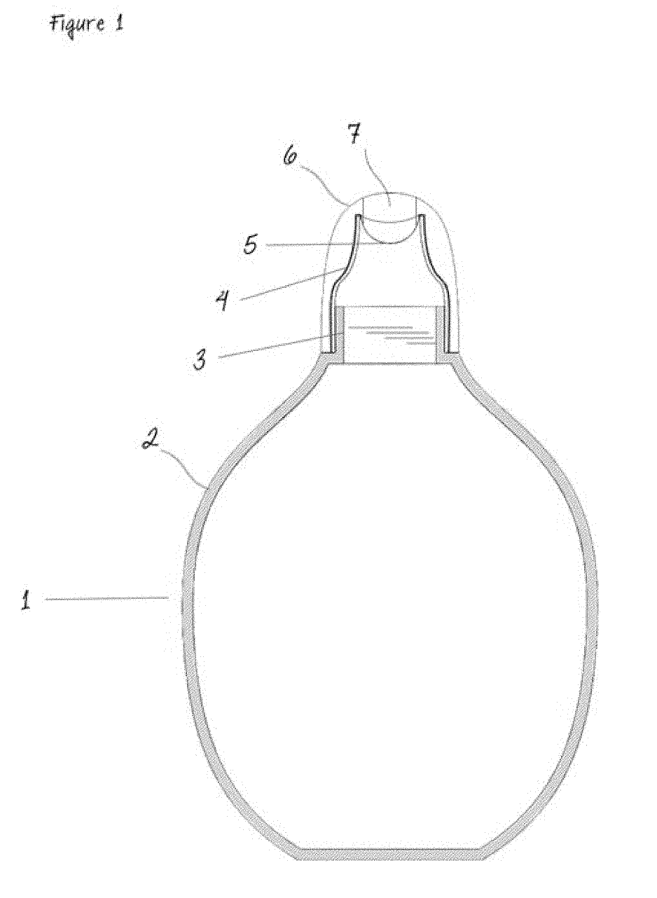

Referring now particularly to the view in FIG. 1, there is shown the container, which is preferably made of rubber, closed at the bottom as at 1 and open at the top as at 5. The below disclosure is written to show examples of measurements in which the container can be made; however larger or smaller proportions or lengths can apply for making this product so the design is not exclusive to the measurements provided here as an example. Features or parts of this product made be lengthened, shortened, widened or enlarged to suite different needs and uses.

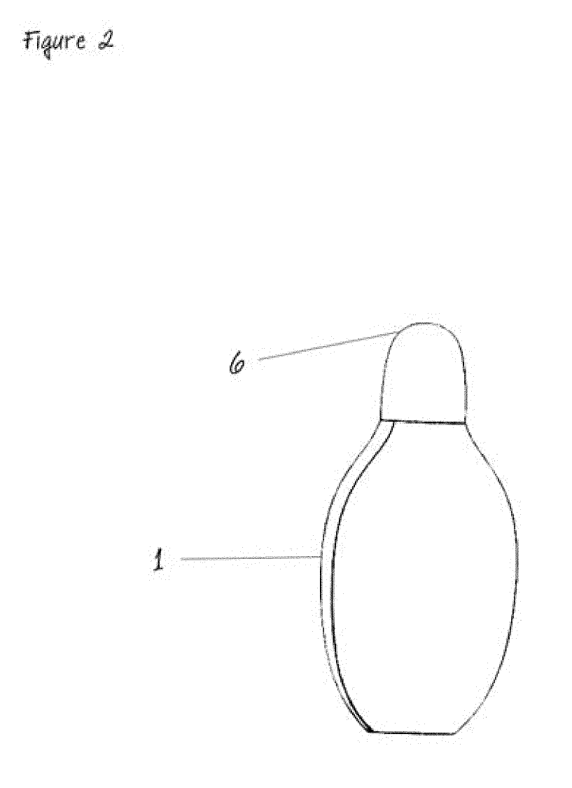

The flexible, squeezable, hollow container is in the shape of an elliptical structure and is 4.5 inches in diameter and 7 inches in length. At the top, however, as may be seen at 3, there is a twist-top interlocking ring and is 2 inches in diameter, so that this elliptically-shaped pouch or container may be closed or opened, as will be mentioned shortly. Additionally, the interlocking ring at 3 will ensure that 4 remain in place during feeding. The exploded view in FIG. 2 further illustrates the separate components that comprise the baby food container.

The top in FIG. 1, as may be seen at 4, twists onto the interlocking ring which functions as a mouthpiece or spout from which the pureed food will exit container 1 through the opening, as may be seen at 5. The elliptical shaped opening at 5 has a length of 0.65 inches and width of 0.3 inches that is wide enough for pureed food to fit through via the combined action of squeezing and sucking, but narrow enough so that too much food does not superfluously pour out at once into the infant's mouth. The required sucking and squeezing actions are meant to diminish the chances of food contents spilling or pouring onto the baby or preventing overfeeding of the baby too quickly. The top, as may be seen at 4, is 1.75 inches in width at the base and a width of 0.75 inches at the narrow-most point at the top.

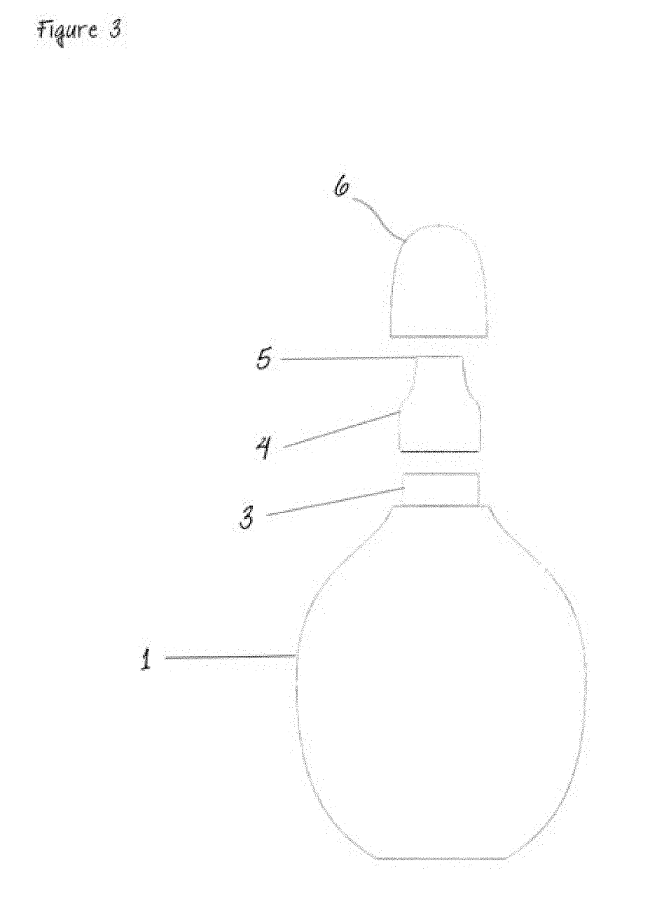

The cylindrical-shaped cap in FIG. 1, as may be seen at 6, is snapped into place at the base of 3 and contents of the container may be sealed air-tight, so as to help maintain the temperature of said contents for several hours at a time. Additionally, attached to the cylindrical-shaped top is a convex nib located in the top interior of the cap as may be seen at 7, which fits inside opening 5, to seal the mouthpiece or spout to further ensure that food contents are kept fresh and do not pour out into the cap while being transported. The perspective view in FIG. 3 further depicts how the interlocking ring and spout are entirely covered by the cap at 5. Furthermore, the exploded view in FIG. 2 illustrates the separate components of the baby food container.

Focusing now on the container walls shown in FIG. 1, there may be seen a surface area that is free of sharp edges and made of a rubber layer approximately 3 mm in width which acts as an insulator and buffer should the container be dropped against a surface. The width of the container walls is also intended to create resistance so that pureed food contents will not so easily pour out should the container be accidentally squeezed or lightly pressed.

Now, the removability of twist-top at 3 shown in FIG. 3 allows the ability to have an opening of a nearly 2 inch-diameter at the top of the container so that the interior may be conveniently washed and pureed food contents may be more easily poured in, which makes the container reusable and sanitary for reuse. The opening, at 3, upon being twisted off, is formed after creating an elliptically-shaped mold for rubber, cutting it to size, and then molding a ring that fits to twist on or off the diameter of the rubber container's top. This plastic cylindrical ring acts as an insulator, at the same time is very light and pliable, and not only will act as an insulator but will also act as a buffer or shock absorber in case container 1 is dropped, Furthermore, the cap at 5 may easily be withdrawn from the interlocking ring at 3 after the rubber container 1 is removed, and then each of the pieces (1, 3, 5) may be independently washed in case any food contents have been spilled.

As for functionality, with its pureed or blended contents placed within container 1. it will also be understood, although it is not shown, that as a safety precaution the design of the elliptical shaped structure combined with the width of the container walls (3 mm), rectangular shaped opening at the spout, angle of the spout's placement and width of the spout itself facilitate a need for sucking and squeezing of the container, in order for the food to escape the spout.

As mentioned above, the container is squeezable so that if the baby wants to eat from the container when he or she is sitting up or leaning back, the rubber container may be held with the baby's hands to squeeze food into his/her mouth so that the baby can take the food from the container in its thus-supported position.

Made by various types of materials, the container can help keep the temperature of the food for longer lengths of hours. Warm food will keep the contents warm for two to three hours; and, alternatively, should the container be filled with cold pureed fruit, it will keep cold for a longer time.

The rubber insulator 1 shown in FIG. 1, as heretofore mentioned, is light in weight. The entire container can weigh less than 6 ounces and can easily be carried in one hand; and even if it were knocked around, dropped or thrown, there is no danger of the container breaking.

Finally, the container is one that is relatively cost-effective to manufacture and the parts are easily assembled.

Having thus described my invention, what I claim as new and desire to secure by Letters Patent is:

1. A reusable container for baby food, comprising: a flexible pouch elliptical in shape, closed at its bottom and open at its top; a cylindrical interlocking ring at the top of the pouch; a snap-into-place cap for the base of the spout, tubular in form; a means for closing and sealing the top of the container's spout with a convex nib in the top interior of the cap; a rubber-like spout removably twisting on top of the pouch via the interlocking ring, the length of the spout being slightly shorter than the length of the snap-into-place cap; the cap, with the spout inside of it, is of a slightly shorter length than the width of the interlocking ring, and substantially greater in length than the spout, ring and cap, that is, more than three times the length of the top, is the flexible pouch.

2. The reusable container for baby food in claim 1 wherein the body of the container is flexible and squeezable for food contents within to be pushed out.

3. The reusable container in claim 1 wherein the body of the container functions as an insulator to maintain the temperature of the food.

4. The reusable container in claim 1 wherein the elliptical shape of the container and the rectangular shaped hole of the spout-top prevent food from pouring out of the spout unless it is squeezed and sucked at the same time.

5. The reusable container in claim 1 wherein the cap further comprised of a convex nib to create an airtight seal or stopper for the opening of the spout.

6. The reusable container in claim 1 wherein the interlocking ring twists on, connects and locks together the top and body of the container.
